(19) United States
(12) Patent Application Publication
(10) Pub. No.: US 2026/0267972 A1
(43) Pub. Date: Sep. 10, 2026

(54) SYSTEM AND METHOD FOR DETECTING A LASER VOLTAGE PROBING ATTACK ON A CHIP

(71) Applicant: National University of Singapore, Singapore (SG)

(72) Inventors: Hui Zhang, Singapore (SG); Qiang Fang, Singapore (SG); Udara Samurdhi Harshanga Kalingage, Singapore (SG); Longyang Lin, Singapore (SG); Massimo Alioto

(21) Appl. No.: 19/491,293

(22) PCT Filed: Jun. 7, 2024
(86) PCT No.: PCT/SG2024/050380

§ 371 Date: Dec. 8, 2025

(30) Foreign Application Priority Data
Jun. 9, 2023 (SG) 10202301634P

(51) Int. Cl. G06F 21/55; G01K 7/01

(52) U.S. Cl. CPC G06F 21/554; G01K 7/01; G06F 2221/034

(57) ABSTRACT

A system for detecting a laser voltage probing (LVP) attack on a chip is described in an embodiment. The system comprising temperature sensors provided at predetermined intervals on the chip. Each of the temperature sensors comprises at least one transistor in an off-state. The at least one transistor of each temperature sensor is adapted to provide an increase in a leakage current in response to a rise in temperature caused by the LVP attack for detecting the LVP attack on the chip. A method for detecting a laser voltage probing attack on a chip is also described in an embodiment.

### TECHNICAL FIELD

The present disclosure relates to a system and method for detecting a laser voltage probing (LVP) attack on a chip.

### BACKGROUND

Laser voltage probing (LVP) attacks are effective in extracting on-chip secrets in view of their ~100% success rate, low costs (e.g. approximately thousands of dollars), and easily assessible required equipment (e.g. equipment available from laboratories providing chip reliability and failure analysis services). A LVP attack sought to recover any on-chip digital voltage by averaging the power backscattered by logic gates under the LVP attack.

Comparing with laser fault injection (LFI) attacks, LVP attacks are much harder to detect as they do not perturb circuit operations. LVP attacks use a longer wavelength typically above a bandgap of more than 1.1 μm, a lower laser power in the range of mW and a finer laser spot down to approximately the size of a single transistor. LVP attacks thereby generate a negligible bulk current and are generally not detectable with sparsely placed sensors typically used for LFI attack detection. LVP attacks are therefore a very concerning threat to chip security, and requires in-situ sensing in a chip.

Existing LVP attack detection schemes have their limitations. For example, some only work for static signals which are unrealistic and not practical, while others cannot achieve full-area coverage due to their short sensing range and substantial power and/or area penalty. Photo-sensors have been used for LVP attack detection to achieve 100% area coverage but at the expense of a large area overhead of about 150%. Another LVP detection scheme which involves concealing gates can easily be circumvented by state-of-the-art LVP equipment with a sub-cell spatial resolution.

It is therefore desirable to provide a system and method for detecting a laser voltage probing attack on a chip which address the aforementioned problems and/or provide a useful alternative. Further, other desirable features and characteristics will become apparent from the subsequent detailed description and the appended claims, taken in conjunction with the accompanying drawings and this background of the disclosure.

### SUMMARY

Aspects of the present application relate to a method and system for detecting a laser voltage probing (LVP) attack on a chip.

In accordance with a first aspect, there is provided a system for detecting a laser voltage probing (LVP) attack on a chip, the system comprising: temperature sensors provided at predetermined intervals on the chip, each of the temperature sensors comprising at least one transistor in an off-state, wherein the at least one transistor of each temperature sensor is adapted to provide an increase in a leakage current in response to a rise in temperature caused by the LVP attack for detecting the LVP attack on the chip.

By using temperature sensors provided at predetermined intervals on the chip, thermal effects induced by a laser beam of a LVP attack can be utilised for LVP attack detection which in turn yields a lower area cost compared to other on-chip LVP detection schemes. Further, by employing at least one transistor in a temperature sensor and using an increase in a leakage current in response to a rise in temperature caused by a LVP attack for detecting the LVP attack, an always-on LVP attack detection system can be achieved with low or negligible power costs. The use of transistors for detecting a laser voltage probing (LVP) attack on a chip is also a low-cost and economical on-chip detection system, where 100% area coverage of the chip can be achieved by sparsely pre-placing temperature/thermal sensors at regular interval in the chip. In particular, the temperature/thermal sensors make use of the much longer radius/area of a thermal field induced by an LVP attack as compared to an optical field induced by the LVP attack for detection, thereby allowing the thermal sensors to be sparsely placed within the chip for a lower area overhead compared to the use of optical sensors.

The temperature sensors may be formed into sensor clusters, each of the sensor clusters may include a predetermined number of the temperature sensors and may be arranged at a predetermined distance from one another.

The system may comprise a detector adapted to be connected to a first and a second of the sensor clusters, the detector may comprise a current comparator and a logic circuitry adapted to compare a first leakage current associated with the first sensor cluster and a second leakage current associated with the second sensor cluster, wherein a count for the LVP attack is registered if a ratio between the first leakage current and the second leakage current exceeds a predetermined ratio.

Wherein the first sensor cluster may comprise a first set of thirty-two of the temperature sensors, the first set of thirty-two of the temperature sensors being distributed in four cell rows with each cell row having eight of the first set of thirty-two of the temperature sensors and the second sensor cluster may comprise a second set of thirty-two of the temperature sensors, the second set of thirty-two of the temperature sensors being distributed in another four cell rows with each cell row having eight of the second set of thirty-two of the temperature sensors, the first sensor cluster and the second sensor cluster may be arranged on opposite sides to each other and may be placed symmetrically with respect to the detector.

Each of the temperature sensors may be provided at eight poly-pitches from one another within each cell rows in the first sensor cluster and the second sensor cluster.

Wherein the current comparator and the logic circuitry may include a pair of n-channel metal-oxide semiconductor (NMOS) current mirrors adapted to compare a respective p-channel metal-oxide semiconductor (PMOS) leakage current between the first sensor cluster and the second sensor cluster and a skewed inverter, the detector may comprise: a further current comparator and a further logic circuitry including a pair of PMOS current mirrors adapted to compare a respective NMOS leakage current between the first sensor cluster and the second sensor cluster and a further skewed inverter; and an XNOR logic gate adapted to generate a detector output based on a first output obtained using the pair of NMOS current mirrors and the skewed inverter and a second output obtained using the pair of PMOS current mirrors and the further skewed inverter, wherein the first output is flipped if a ratio between the respective PMOS leakage current of the first sensor cluster and the second sensor cluster exceeds the predetermined ratio, and the second output is flipped if a ratio between the respective NMOS leakage current of the first sensor cluster and the second sensor cluster exceeds the predetermined ratio, and wherein initial values of the first output and the second output may include a “1” and “0” binary pair as initial inputs to the XNOR logic gate, and the detector output generated by the XNOR logic gate may be a high output or “1” if the first output or the second output is flipped.

The temperature sensors may be arranged in a diamond shape configuration on the chip.

One or more of the temperature sensors may be provided within a digital standard cell on the chip if a size of the digital standard cell exceeds a predetermined number of pitches or poly-pitches on the chip.

In accordance with a second aspect, there is provided a method for detecting a laser voltage probing (LVP) attack on a chip, the method comprising: providing temperature sensors at predetermined intervals on the chip, each of the temperature sensors comprising at least one transistor in an off-state, wherein the at least one transistor of each temperature sensor is adapted to provide an increase in a leakage current in response to a rise in temperature caused by the LVP attack for detecting the LVP attack on the chip.

The method may comprise forming the temperature sensors into sensor clusters, each of the sensor clusters may include a predetermined number of the temperature sensors and are arranged at a predetermined distance from one another.

The method may comprise: providing a detector adapted to be connected to a first and a second of the sensor clusters, the detector comprising a current comparator and a logic circuitry; and comparing, using the detector, a first leakage current associated with the first sensor cluster and a second leakage current associated with a second sensor cluster, wherein a count for the LVP attack is registered if a ratio between the first leakage current and the second leakage current exceeds a predetermined ratio.

Wherein the first sensor cluster may comprise a first set of thirty-two of the temperature sensors, the first set of thirty-two of the temperature sensors may be distributed in four cell rows with each cell row having eight of the first set of thirty-two of the temperature sensors and the second sensor cluster may comprise a second set of thirty-two of the temperature sensors, the second set of thirty-two of the temperature sensors may be distributed in another four cell rows with each cell row having eight of the second set of thirty-two of the temperature sensors, the method may comprise: arranging the first sensor cluster and the second sensor cluster to be formed on opposite sides to each other and symmetrically placed with respect to the detector.

The method may comprise: providing each of the temperature sensors at eight poly-pitches from one another within each cell rows in the first sensor cluster and the second sensor cluster.

Wherein the current comparator and the logic circuitry may include a pair of n-channel metal-oxide semiconductor (NMOS) current mirrors and a skewed inverter, and wherein the detector may comprise a further current comparator and a further logic circuitry including a pair of p-channel metal-oxide semiconductor (PMOS) current mirrors and a further skewed inverter, and an XNOR logic gate, the method may comprise: comparing, using the pair of NMOS current mirrors and the skewed inverter, a respective PMOS leakage current between the first sensor cluster and the second sensor cluster, a first output associated with the current comparator and the logic circuitry is flipped if a ratio between the respective PMOS leakage current of the first sensor cluster and the second sensor cluster exceeds the predetermined ratio; comparing, using the pair of PMOS current mirrors and the further skewed inverter, a respective NMOS leakage current between the first sensor cluster and the second sensor cluster, a second output associated with the further current comparator and the further logic circuitry is flipped if a ratio between the respective NMOS leakage current of the first sensor cluster and the second sensor cluster exceeds the predetermined ratio; and generating, using the XNOR logic gate, a detector output based on the first output and the second output, wherein initial values of the first output and the second output includes a “1” and “0” binary pair as initial inputs to the XNOR logic gate, and the detector output generated by the XNOR logic gate is a high output or “1” if the first output or the second output is flipped.

The method may comprise arranging the temperature sensors in a diamond shape configuration on the chip.

The method may comprise providing one or more of the temperature sensors within a digital standard cell on the chip if a size of the digital standard cell exceeds a predetermined number of pitches or poly-pitches on the chip.

Each temperature sensor may comprise a first transistor having a first source and a first gate connected to a voltage source of a cell on the chip and a second transistor having a second source and a second gate connected to a ground of the cell.

It should be appreciated that features relating to one aspect may be applicable to the other aspects. Embodiments provide a method and system for detecting a laser voltage probing (LVP) attack on a chip. Particularly, by using temperature sensors provided at predetermined intervals on the chip, thermal effect induced by a laser beam of a LVP attack can be utilised for LVP attack detection which in turn yields a lower area cost compared to other on-chip LVP detection schemes. Further, by employing at least one transistor in a temperature sensor and using an increase in a leakage current in response to a rise in temperature caused by a LVP attack for detecting the LVP attack, an always-on LVP attack detection system and method can be achieved with low or negligible power costs. The use of transistors for detecting a laser voltage probing (LVP) attack on a chip is also a low-cost and economical on-chip detection system and method, where 100% area coverage of the chip can be achieved by sparsely pre-placing temperature/thermal sensors at regular interval in the chip. In particular, the temperature/thermal sensors make use of the much longer radius/area of a thermal field induced by an LVP attack as compared to an optical field induced by the LVP attack for detection, thereby allowing the thermal sensors to be sparsely placed within the chip for a lower area overhead compared to the use of optical sensors. In an embodiment, the system and method for detecting a LVP attack on a chip includes a detector comprising a current comparator and a logic circuitry adapted to compare a first leakage current associated with a first cluster of temperature sensors and a second leakage current associated with a second cluster of temperature sensors, where a count for the LVP attack is registered if a ratio between the first leakage current and the second leakage current exceeds a predetermined ratio. By having a detector configured to compare leakage currents between the first cluster and the second cluster, any reference is avoided and leakage mismatches across the temperature sensors can be averaged out. Further, by registering a LVP attack if the ratio between the first leakage current and the second leakage current exceeds a predetermined ratio, this differential structure is inherently robust against Process-Voltage-Temperature (PVT) variations and supply noise of the chip. The detector, in an embodiment, can be deployed using a fully-automated standard-cell based design for easy and wide adoption and system integration, and design-agnostic deployment. Still further, temperature sensors in the present disclosure are designed with a minimum size and in a standard cell manner so that they are compatible with conventional digital design flow. This means that the temperature sensors can be directly deployed for any IC chip designs, and therefore “design-agnostic”.

### BRIEF DESCRIPTION OF THE DRAWINGS

Embodiments will now be described, by way of example only, with reference to the following drawings, in which:

FIG. 1 is a schematic diagram illustrating laser voltage probing (LVP) attacks on a chip in accordance with an embodiment;

FIG. 2 is a diagram illustrating a temperature sensor and a layout of a plurality of the temperature sensors provided on a chip in accordance with an embodiment;

FIG. 3 is a diagram illustrating a system architecture comprising a detector for detecting LVP attacks using the plurality of temperature sensors of FIG. 2 in accordance with an embodiment;

FIG. 4 is a flowchart of a method for detecting a laser voltage probing (LVP) attack on a chip accordance with an embodiment;

FIG. 5 shows a micrograph of a test chip comprising arrays of the temperature sensors of FIG. 2 in accordance with an embodiment;

FIG. 6 is a graph showing transient measurements detected using the system architecture of FIG. 3 under a LVP attack in accordance with an embodiment;

FIGS. 7A and 7B are graphs to illustrate effects of thermal process variations on detection using the system architecture of FIG. 3 in accordance with an embodiment, where FIG. 7A shows a graph to illustrate effects of thermal process variation in relation to PMOS sensors and FIG. 7B shows a graph to illustrate effects of thermal process variation in relation to NMOS sensors;

FIGS. 8A and 8B are graphs to illustrate effects of temporal noise on detection using the system architecture of FIG. 3 in accordance with an embodiment, where FIG. 8A shows a graph to illustrate effects of temporal noise in relation to PMOS sensors and FIG. 8B shows a graph to illustrate effects of temporal noise in relation to NMOS sensors;

FIG. 9 shows a graph of signal to noise ratio (SNR) versus a number of acquisitions of a LVP attack having various laser powers in accordance with an embodiment;

FIG. 10 shows an infrared thermal image of an array of temperature sensors on a chip having ring oscillators running at a frequency of 8.06 GHz in accordance with an embodiment;

FIG. 11 shows diagrams illustrating successful detection of a LVP laser beam using the layout of the plurality of the temperature sensors of FIG. 2 in accordance with an embodiment;

FIGS. 12A, 12B and 12C are diagrams illustrating detection of a LVP attack on a chip with full-area detection coverage using sensor clusters provided at a left-side and a right-side of a detector in accordance with an embodiment, where FIG. 12A is a micrograph showing the sensor clusters provided at the left-side and the right-side of the detector, FIG. 12B is a graph of sensing voltage V_{sense P} versus a position of a laser spot of the LVP attack measured using the left-side sensor clusters and FIG. 12C is a graph of sensing voltage V_{sense N} versus a position of the laser spot of the LVP attack measured using the right-side sensor clusters;

FIG. 13 shows a pie chart of a leakage power breakdown in accordance with an embodiment;

FIG. 14 shows a pie chart of a silicon area breakdown in accordance with an embodiment; and

FIGS. 15A, 15B and 15C shows graphs to illustrate optical power distribution radius and thermal field radius of a laser beam spot in accordance with an embodiment, where FIG. 15A shows a 2D colour contour plot of normalised optical field intensity in relation to a X-transverse distance and a Y-transverse distance of the laser beam spot, FIG. 15B shows a plot of the normalised optical field intensity verse the X-transverse distance of the laser beam spot and FIG. 15C shows a plot of detected current using a temperature sensor versus a distance of the laser beam spot centre from the temperature sensor.

### DETAILED DESCRIPTION

Exemplary embodiments relate to a method and system for detecting a laser voltage probing (LVP) attack on a chip.

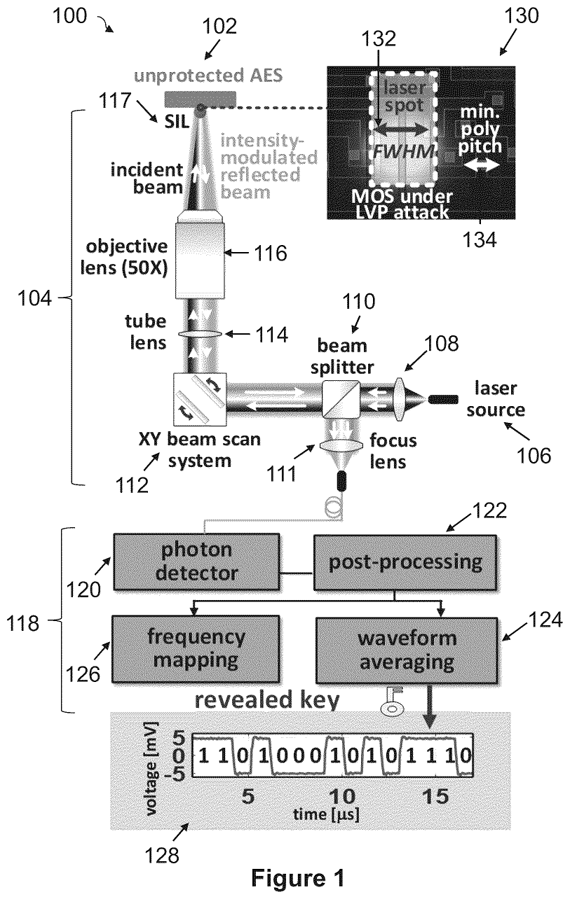

FIG. 1 is a schematic diagram 100 illustrating laser voltage probing (LVP) attacks on a chip in accordance with an embodiment.

As shown in FIG. 1, an unprotected Advanced Encryption Standard (AES) chip 102 can face a LVP attack provided by an optical setup 104. The optical setup 104 includes a laser source for providing a laser beam. The laser beam passes through a focus lens 108 for focusing the laser beam, and the focused laser beam is transmitted to a beam splitter 110 which is adapted to split the focused laser beam into a transmitted laser beam and a reflected laser beam. The transmitted laser beam is transmitted to a XY beam scan system 112 which is adapted to reflect the transmitted laser beam through a tube lens 114 towards an objective lens 116, while the reflected laser beam is reflected towards a further focus lens 111. The transmitted beam is focused by the objective lens 116 and further focused by solid immersion lens (SIL) 117. The SIL 117 is adapted to focus the transmitted beam at the SIL's focal point to form an incident laser beam having a spot size of about 200 nm in full-width at half-maximum (FWHM) on the AES chip 102 for conducting the LVP attack on the AES chip 102. The incident laser beam is reflected off the AES chip 102 to form an intensity-modulated reflected laser beam. The intensity-modulated reflected laser beam is transmitted via the SIL 117, the objective lens 116, the tube lens 114, the XY beam scan system 112 towards the beam splitter 110. The intensity-modulated reflected laser beam is reflected by the beam splitter 110 towards the further focus lens 111. The intensity-modulated reflected laser beam, together with the reflected laser beam, are used by an electronic setup 118 for extracting an encrypted key or information from the AES chip 102. The reflected laser beam acts as a reference signal for information extraction and may be used to subtract unwanted noise.

The electronic setup 118 includes a photon detector 120 adapted to detect the intensity-modulated reflected laser beam, and convert them to appropriate digital/electrical signals for post processing 122. For the post processing 122, the digital signals from the photon detector 120 are processed (e.g. by amplifying amplitudes of the digital signals) for subsequent steps of waveform averaging 124 (to suppress noise and display timing waveforms) and/or frequency mapping 126. In an LVP attack, an electrical node or component of the AES chip 102 operating at a frequency of interest will modulate a light reflected off it with said frequency. This translates to the intensity-modulated reflected laser beam providing digital signals being modulated with this frequency. By plotting variations in the intensity-modulated reflected laser beam digital signal versus time, a timing waveform of the digital signal of the component of the AES chip 102 can be extracted. Additional measurements of the AES chip 102 are acquired and averaged into previous measurements during waveform averaging 124. Over time, the waveform averaging 124 provides a time-averaged backscattered power waveform 128 associated with the intensity-modulated reflected laser beam for recovering a plaintext or a key. Data extracted or generated after post-processing 122 can also be used to form a frequency mapping 126. By using the post-processed digital signals received from the photo detector 120, the frequency mapping 126 is configured to generate a grayscale image of the device under test (DUT) (i.e. the AES chip 102 e.g. an AES-128 processor) where the circuit nodes switching at the frequency of interest are highlighted as bright dots and all other places are dark in colour. This helps users or the attackers to identify locations on the AES chip 102 for which they wish to probe for generating a timing waveform (e.g. by using the aforementioned step of waveform averaging 124). It should be appreciated that, the frequency mapping process 126 can be used independently (i.e. a stand-alone step) for e.g. frequency inspection of the DUT and other applications.

An inset 130 shows a diagram to illustrate a laser spot on the AES chip 102 used to perform the LVP attack. A Full Width Half Maximum (FWHM) 132 of an intensity of the laser spot can be used to gauge a spot size of the laser spot. A minimum poly pitch 134 (i.e. a distance between adjacent gating lines of a chip) of the AES chip 102 is also shown which is larger than the spot size of the laser spot. This means that LVP attacks can be spatially very precise and can be used to probe individual transistors or power nets and to locate transistors or power nets of interest very accurately. This also means that localised sensors in the chip have to be provided for detecting a LVP attack.

To reduce area overhead, in embodiments of the present disclosure, temperature sensors are provided at predetermined intervals on the chip to make use of a thermal field induced by a laser beam of a LVP attack for detection. Indeed, the thermal field induced by the laser beam (>400° C.) has a half-maximum power radius that is much longer than the laser optical power density distribution. This allows temperature sensors to be sparsely placed in the chip, yet providing an approximately 100% area coverage of the chip.

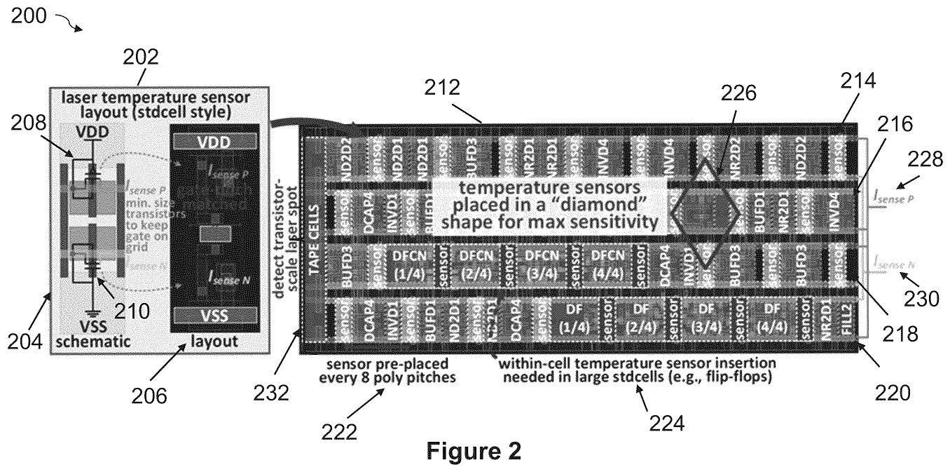

FIG. 2 is a diagram 200 illustrating a temperature sensor and a layout of a plurality of the temperature sensors provided on a chip in accordance with an embodiment.

As shown in FIG. 2, an inset 202 provides a schematic of a temperature sensor 204 and a micrograph of the temperature sensor 204 showing a layout 206 of the temperature sensor 204. As shown in the inset 202, in the present embodiment, the temperature sensor 204 comprises two off-transistors (or off-state transistors) where a first off-transistor 208 includes a first source and a first gate both being shorted and connected to a supply voltage V_{DD} of a cell, and a second off-transistor 210 includes a second source and a second gate both being shorted and connected to a ground V_{SS} of the cell. In the present embodiment, the first transistor 208 and the second transistor 210 are adapted to provide an increase in a leakage current in response to a rise in temperature caused by the LVP attack for detecting the LVP attack on the chip. As shown in the layout 206, the temperature sensor 204 can be formed or provided within a gate-pitch or a poly pitch of the chip.

A portion 212 of the chip having a plurality of temperature sensors formed thereon is also shown in FIG. 2. Four cell rows 214, 216, 218, 220 of the portion 212 of the chip are shown, and in the present embodiment, each of these cell rows 214, 216, 218, 220 includes eight temperature sensors. In the present embodiment, the four cell rows 214, 216, 218, 220 forms a sensor cluster. There are therefore a total of thirty-two temperature sensors in the sensor cluster as shown in this portion 212 of the chip. In the present embodiment, each of the temperature sensors is provided at eight poly-pitches from one another within each of the cell rows 214, 216, 218, 220. This is labelled as 222. Also shown in the portion 212 is that if a size of a digital standard cell exceeds a predetermined number of pitches or poly-pitches on the chip, then one or more of the temperature sensors can be provided within the digital standard cell. For example, in the present case, four temperature sensors are provided within a large digital standard cell (e.g. a flip-flop etc.) and this is shown as 224. Also shown in FIG. 2, is that the temperature sensors are arranged in a diamond shape configuration on the chip for maximum detection sensitivity. An example of the diamond shape configuration 226 is shown.

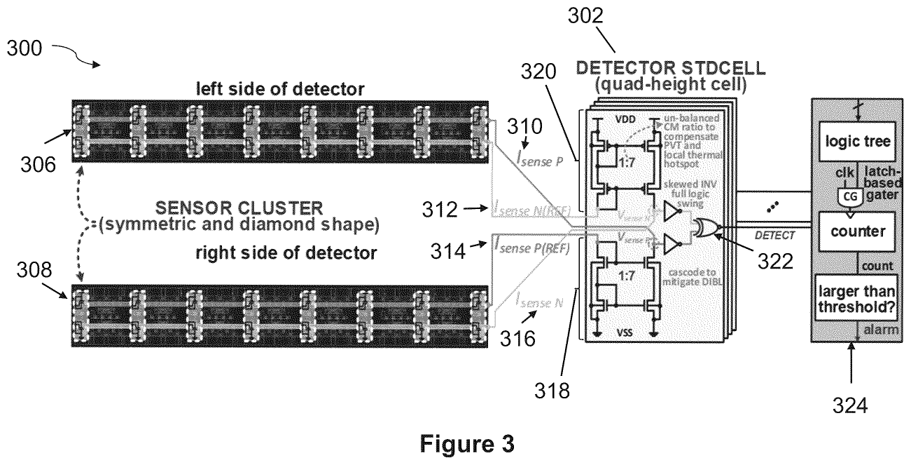

Leakage currents from first off-transistors of the temperature sensors within the sensor cluster can be aggregated to provide a combined I_{sense P} 228 and leakage currents from second off-transistors of the temperature sensors within the same sensor cluster can be aggregated to provide a combined I_{sense N} 230. A detector can be provided to aggregate the various combined outputs from the temperature sensors and this is discussed in relation to FIG. 3 below.

FIG. 3 is a diagram illustrating a system architecture 300 comprising a detector 302 for detecting LVP attacks using the plurality of temperature sensors of FIG. 2 in accordance with an embodiment.

As shown in relation to FIG. 2, thirty-two sensors are pre-placed within the four cell rows for adequate spatial proximity and area coverage to form a sensor cluster. In the present embodiment, two sensor clusters each having thirty-two temperature sensors feeds a detector 302 or a detector standard cell having a quad-cell height. One or more detector standard cells can be pre-placed at regular intervals, corresponding to the placement of corresponding one or more sensor clusters. In the present embodiment, because the thirty-two temperature sensors are pre-placed within the four cell rows, the detector 302 is configured to also have a same transverse dimension 232 as the four cell rows or quad-height (i.e. one cell row has a dimension of one height), to automatically abut and align with a sensor cluster to ease a digital design flow of the chip. The present embodiment therefore provides a “design-agnostic” concept, that is, regardless of a computer hardware or component for protection (in the present embodiment, an AES core), sensor clusters can be placed together with the detector standard cells and they are automatically abutted and can be connected with no extra efforts to fine tune their positions or to provide additional metal routing for connection. Referring to FIG. 2, it therefore shows an example of a four cell-rows configuration for auto abutment.

Referring to FIG. 3, in the present embodiment, a first sensor cluster 306 comprising a first set of thirty-two of the temperature sensors and a second sensor cluster 308 comprising a second set of thirty-two of the temperature sensors are connected to the detector 302. As shown in FIG. 3, the first sensor cluster 306 and the second sensor cluster 308 are arranged on opposite sides to each other and are placed symmetrically with respect to the detector 302. In the present case, leakage currents from first transistors of the temperature sensors within the first sensor cluster 306 are aggregated to provide a combined I_{sense P} 310 and leakage currents from second transistors of the temperature sensors within the first sensor cluster 306 are aggregated to provide a combined I_{sense N (REF)} 312. On the other hand, leakage currents from first transistors of the temperature sensors within the second sensor cluster 308 are aggregated to provide a combined I_{sense P (REF)} 314 and leakage currents from second transistors of the temperature sensors within the second sensor cluster 308 are aggregated to provide a combined I_{sense N} 316. These currents I_{sense P} 310, I_{sense N (REF)} 312, I_{sense P (REF)} 314 and I_{sense N} 316 are fed into the detector 302 for processing. As shown in FIG. 3, there are therefore two sensor clusters having a total of sixty-four temperature sensors in this sensor-detector pair. In the present embodiment, this sensor-detector pair forms one minimum unit.

The detector 302 comprises a first current comparator and first logic circuitry 318 which includes a pair of n-channel metal-oxide semiconductor (NMOS) current mirrors and a skewed inverter adapted to compare a respective p-channel metal-oxide semiconductor (PMOS) leakage current between the first sensor cluster of temperature sensors and the second sensor cluster of temperature sensors (i.e. by comparing the currents I_{sense P} 310 of the first sensor cluster 306 and I_{sense P (REF)} 314 of the second sensor cluster 308), and a second current comparator and a second logic circuitry 320 including a pair of PMOS current mirrors and a further skewed inverter adapted to compare a respective NMOS leakage current between the first sensor cluster 306 of temperature sensors and the second sensor cluster 308 of temperature sensors (i.e. by comparing the currents I_{sense N (REF)} 312 of the first sensor cluster and I_{sense N} 316 of the second sensor cluster). The detector 302 therefore is adapted to compare the leakages from the sensor cluster at its left with the sensor cluster at its right, avoiding any reference, and averaging leakage mismatch across the temperature sensors.

In the present case, an unbalanced current mirror ratio of 1:7 can be set for both the pair of NMOS current mirrors and the pair of PMOS current mirrors to compensate PVT and local thermal hot spots in the chip. An output voltage of each of these pairs of current mirrors only flips when one of the two currents (e.g. I_{sense P} 310 or I_{sense N} 316) becomes much higher (in this case, more than 7 times higher) than the corresponding current of the current pair (e.g. I_{sense P (REF)} 314 or I_{sense N (REF)} 312). To explain this, without considering variations due to fabrication imperfectness, each of the sensor clusters 306, 308 has its own current flowing in an initial state or an idle state when there is no LVP laser attack. Turning to the pair of NMOS current mirrors connected to the I_{sense P} 310 and I_{sense P (REF)} 314, at the initial state or the idle state without a LVP attack, because the current mirrors is designed with 1:7 mirroring ratio and that the I_{sense P} 310 and I_{sense P (REF)} 314 provide similar currents, the output of the current mirrors is very close to 0 (ground). This is because the current mirrors copied a 7×I_{sense P (REF)} 314 associated with the second sensor cluster 308 on the right side of the detector 302. If the first sensor cluster 306 (i.e. the left side of the detector 302) is hit by a LVP laser beam, the temperature at the left side of the detector 302 is much higher and the I_{sense P} 310 becomes larger than the copied 7×I_{sense P (REF)} 314. When I_{sense P} 310 is sufficiently high, the output of the pair of NMOS current mirrors will start to flip, from low (“0”) to high (“1”). Similar principle is applied to the other pair of PMOS current mirrors and the NMOS sensing currents (i.e. I_{sense N} 316 and I_{sense N (REF)} 312). It should also be appreciated that, if an LVP attack is performed on the side of the reference currents (i.e. I_{sense P (REF)} 314 or I_{sense N (REF)} 312), the output of the corresponding current mirrors will only be strengthened and remain the same, but not flipped. Therefore, in the present embodiment, two sensing currents (e.g. sensing currents from a PMOS off-transistor and a NMOS off-transistor of a temperature sensor) and two types of current mirrors are employed for detection of a LVP attack on both the first sensor cluster 306 and the second sensor cluster 308.

The skewed inverters are each adapted to regenerate the corresponding output voltage of these pairs of current mirrors. To explain, each of the skewed inverters is adapted to flip its output based on an input signal's level (in this case the input signals to the skewed inverters are the outputs of the pairs of current mirrors). When an input signal level is high (e.g. “1”), an output of the skewed inverter is low (e.g. “0”), and vice versa. For a symmetric inverter, when its input is half of the power supply voltage (½ V_{DD}), its output is also half of the power supply voltage (½ V_{DD}). In contrast, in the present embodiment, the skewed inverters are asymmetric. This means that a magnitude of an output of a skewed inverter is not the same as a magnitude of an input of the skewed inverter, unlike a symmetric inverter as discussed above (e.g. an output of a skewed inverter is not % V_{DD} when an input to the skewed inverter is % V_{DD}). For example, in the present embodiment, the skewed inverter connected to the NMOS current mirrors in relation to I_{sense P} has its output close to high (e.g. a binary code of “1”); while the skewed inverter connected to the PMOS current mirrors of I_{sense N} has its output close to low (e.g. a binary code of “0”). Therefore, in the present embodiment, initial values or states of outputs from the skewed inverters, without no LVP attack, is “1” and “0”. By using skewed inverters, an overall robustness of the detector 302 against variations induced by fabrication is further improved (the 1:7 mirroring ratio as provided in each of the current mirrors also helped in this purpose, and it can be further strengthened by the skewed inverters). A first output associated with the first current comparator and the first logic circuitry 318 is flipped (in this embodiment, from “1” to “0”) if a ratio between the respective PMOS leakage current of the first sensor cluster and the second sensor cluster exceeds the predetermined ratio of 1:7. Similarly, a second output is flipped (in this embodiment, from “0” to “1”) if a ratio between the respective NMOS leakage current of the first sensor cluster and the second sensor cluster exceeds the predetermined ratio of 1:7.

The detector 302 further comprises an XNOR logic gate 322 in the layer 304. The XNOR logic gate 322 is adapted to generate a detector output based on the first output obtained using the pair of NMOS current mirrors and the skewed inverter and the second output obtained using the pair of PMOS current mirrors and the further skewed inverter. The detector output generated by the XNOR logic gate 322 is a high output or “1” if the first output or the second output is flipped. In other words, when there is no LVP attack, initial inputs to the XNOR logic gate 322 includes a “0” and a “1” binary pair (i.e. the initial outputs from the skewed inverters). When a LVP attack is performed at either the first sensor cluster 306 (i.e. at the left side of the detector 302) or the second sensor cluster 308 (i.e. at the right side of the detector 302), the first output from the skewed inverter associated with the pair of NMOS current mirrors will flip from “1” to “0” or the second output from the skewed inverter associated with the pair of PMOS current mirrors will flip from “0” to “1”, respectively. The inputs to the XNOR logic gate 322 will become a “0” and “0” binary pair or a “1” and “1” binary pair, respectively, and the detector output of the XNOR logic gate 322 will flip to change from “0” to “1”, indicating a high output. The “1” or high output from the XNOR logic gate 322 therefore indicates a presence of a LVP attack to either the first sensor cluster 306 or the second sensor cluster 308.

The overall working principle of the detector 302 or the detector circuit is summarised as follows. A detector 302 or a detector circuit comprising a pair of NMOS current mirrors and a pair of PMOS current mirrors where each of them has a current mirror ratio of 1:7. In addition to the pairs of current mirrors, the detector 302 includes two skewed inverters where each of the two skewed inverters is connected to a respective pair of current mirrors, and a XNOR logic gate 322. The detector 302 in the present embodiment is designed in a quad-height structure, meaning that it has a vertical dimension equivalent to lateral dimensions of four cell-rows. In the present embodiment, each of the first sensor cluster 306 and the second sensor cluster 308 includes thirty-two temperature sensors aggregated all together where these thirty-two temperature sensors are connected in parallel. As shown in relation to FIG. 2, these thirty-two temperature sensors of each sensor cluster are pre-placed across a region or a part of a chip to maximise its responsivity against a LVP laser attack. The present embodiment includes a diamond-shape configuration but in another embodiment, a square-shape configuration is also applicable. In the present embodiment, because there is no guarantee that the laser spot is right on top of a single temperature sensor at any one time, the diamond-shape configuration helps to allow as many temperature sensors as possible to be responsive to a LVP laser attack.

As shown in FIG. 3, each of the first sensor cluster 306 and the second sensor cluster 308 provides two things: a sensing current for LVP attack detection for the sensor cluster itself (i.e. I_{sense P} 310 or I_{sense N} 316, respectively) and a reference current (i.e. I_{sense N (REF)} 312 and I_{sense P (REF)} 314, respectively) for used as a comparison threshold for the other sensor cluster (which will be multiplied by 7 times at the current mirrors).

When there is a LVP attack, the sensor cluster which is being illuminated or attacked experiences an increase in temperature, leading to an increasing leakage currents by the off-transistors of the temperature sensors. Because of this, the sensing current of the illuminated sensor cluster becomes much larger than the 7× of the reference current provided by the other sensor cluster which is not illuminated by the LVP laser. The output of the corresponding pair of current mirrors will flip, thereby resulting in a flipping of an input to the XNOR logic gate 322, leading to a flipping of an output (i.e. from “0” state to “1” state) at the output of XNOR logic gate 322. A LVP attack can therefore be detected.

In the present embodiments, an off-state transistor is used in a temperature sensor because a sub-threshold leakage current of an off-state transistor is exponentially proportional to heat or a rise in temperature. Because a rise in temperature due to a laser spot of a LVP attack is much higher than any other thermal sources on a chip, it can be detected easily. This also provides a reason as to why the present detection method can work without calibration, so long as the current mirror ratio is designed large enough (e.g. 1:7) to give sufficient window for differentiation (but not too large due to area cost consideration).

The afore-described differential structure of the detector 302 for detecting a LVP attack is inherently robust against PVT variations and supply noise.

In the present embodiment, outputs from the detector 302 are aggregated using a logic tree and a counter which are automatically placed and routed, as shown in a block 324.

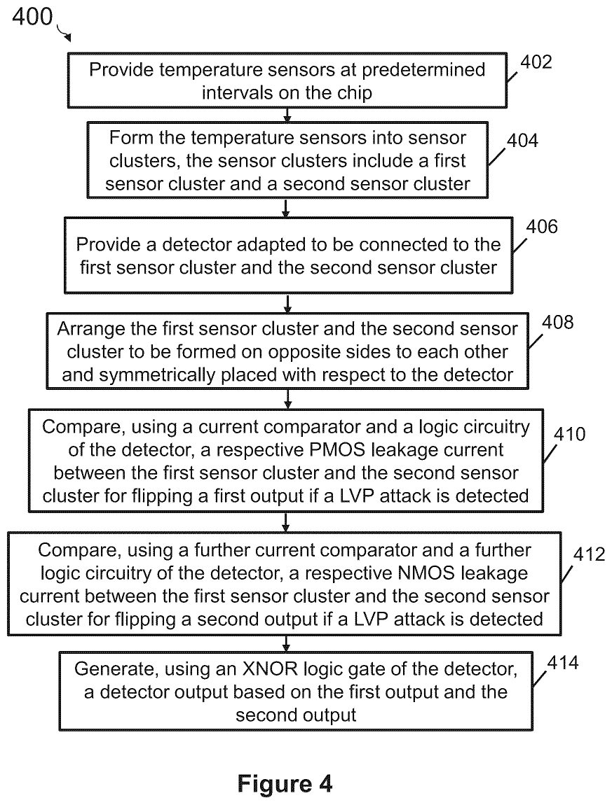

FIG. 4 is a flowchart of a method 400 for detecting a laser voltage probing (LVP) attack on a chip accordance with an embodiment.

In a step 402, temperature sensors are provided at predetermined intervals on the chip, where each of the temperature sensors comprises at least one transistor in an off-state.

The at least one transistor of each temperature sensor is adapted to provide an increase in a leakage current in response to a rise in temperature caused by the LVP attack for detecting the LVP attack on the chip. In an embodiment, the temperature sensors are in a diamond shape configuration on the chip. In an embodiment, one or more of the temperature sensors are provided within a digital standard cell on the chip if a size of the digital standard cell exceeds a predetermined number of pitches on the chip. In an embodiment, the predetermined number of pitches is eight. Each temperature sensor may comprise a first transistor having a first source and a first gate connected to a voltage source of a cell on the chip and a second transistor having a second source and a second gate connected to a ground of the cell.

In a step 404, the temperature sensors are formed into sensor clusters. Each of the sensor clusters includes a predetermined number of the temperature sensors and are arranged at a predetermined distance from one another. In the present embodiment, each of the temperature sensors is provided at eight poly-pitches from one another within each of the plurality of cell rows, may it should be appreciated that this can be varied for other embodiments. In the present embodiment, two sensor clusters are provided. A first sensor cluster comprises a first set of thirty-two of the temperature sensors, the first set of thirty-two of the temperature sensors being distributed in four cell rows with each cell row having eight of the first set of thirty-two of the temperature sensors, and a second sensor cluster comprises a second set of thirty-two of the temperature sensors, the second set of thirty-two of the temperature sensors being distributed in another four cell rows with each cell row having eight of the second set of thirty-two of the temperature sensors.

In a step 406, a detector is provided and it is adapted to be connected to the first sensor cluster and the second sensor cluster for detecting the LVP attack. The detector comprises a current comparator and a logic circuitry adapted to compare a first leakage current associated with the first sensor cluster and a second leakage current associated with a second sensor cluster, wherein a count for the LVP attack is registered if a ratio between the first leakage current and the second leakage current exceeds a predetermined ratio. In an embodiment, the current comparator and the logic circuitry includes a pair of n-channel metal-oxide semiconductor (NMOS) current mirrors adapted to compare a respective p-channel metal-oxide semiconductor (PMOS) leakage current between the first cluster and the second cluster and a skewed inverter, and the detector further comprises a further current comparator and a further logic circuitry including a pair of PMOS current mirrors adapted to compare a respective NMOS leakage current between the first cluster and the second cluster and a further skewed inverter. In the present embodiment, the detector further comprises an XNOR logic gate adapted to generate a detector output based on a first output obtained using the pair of NMOS current mirrors and the skewed inverter and a second output obtained using the pair of PMOS current mirrors and the further skewed inverter.

In a step 408, the first sensor cluster and the second sensor cluster are arranged to be formed on opposite sides to each other and symmetrically placed with respect to the detector.

In a step 410, the current comparator and the logic circuit (i.e. the pair of NMOS current mirrors and the skewed inverter) are used to compare a respective PMOS leakage current between the first sensor cluster and the second sensor cluster for generating a first LVP attack count. In the present embodiment, the first output of the pair of NMOS current mirrors and the skewed inverter is flipped if a ratio between the respective PMOS leakage current of the first sensor cluster and the second sensor cluster exceeds a predetermined ratio. The predetermined ratio may be 1:7.

In a step 412, the further current comparator and the further logic circuit (i.e. the pair of PMOS current mirrors and the further skewed inverter) are used to compare a respective NMOS leakage current between the first sensor cluster and the second sensor cluster for generating a second LVP attack. The second output the pair of PMOS current mirrors and the further skewed inverter is flipped if a ratio between the respective NMOS leakage current of the first sensor cluster and the second sensor cluster exceeds the predetermined ratio.

In a step 414, the XNOR logic gate is used to generate a detector output based on the first output obtained using the pair of NMOS current mirrors and the skewed inverter and the second output obtained using the pair of PMOS current mirrors and the further skewed inverter, wherein initial values of the first output and the second output includes a “1” and “0” binary pair as initial inputs to the XNOR logic gate, and the detector output generated by the XNOR logic gate is a high output or “1” if the first output or the second output is flipped.

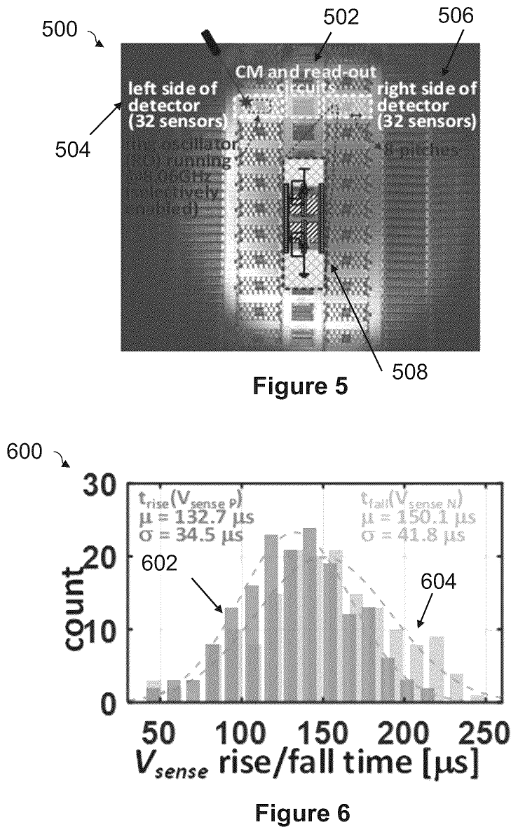

FIG. 5 shows a micrograph of a portion of a test chip 500 comprising arrays of the temperature sensors of FIG. 2 in accordance with an embodiment. The micrograph shows a microscopic view of 5376 temperature sensor array formed on the portion of the test chip 500.

The 28-nm test chip 500 includes a detector 502 comprising current mirrors and read-out circuits as exemplified in relation to FIG. 3. Also shown in FIG. 5 are a “left-side” sensor cluster 504 comprising thirty-two temperature sensors and a “right-side” sensor cluster 506 comprising thirty-two temperature sensors. The “left-side” sensor cluster 504 and the “right-side” sensor cluster 506 are arranged on opposite sides to each other and are placed symmetrically with respect to the detector 502. In the present embodiment, each of the temperature sensors of the “left-side” sensor cluster 504 and the “right-side” sensor cluster 506 is provided at eight poly-pitches from one another within each of the plurality of cell rows in each of these sensor clusters 504, 506. A blown-up section 508 of the “right side” cluster 506 is shown to show a temperature sensor comprising two off-transistors where a first off-transistor includes a first source and a first gate both being shorted and connected to a supply voltage V_{DD} of a cell, and a second off-transistor includes a second source and a second gate both being shorted and connected to a ground V_{SS} of the cell. This is similar to that as illustrated in relation to FIG. 2.

This 28-nm test chip 500 is under extensive LVP attacks and measurements were taken to illustrate performances of the use of temperature sensors as described in the present disclosure. Ring oscillators within the test chip 500 can be selectively enabled and run at 8.06 GHz to generate the following experimental results which will be discussed in relation to FIGS. 6 to 14 below. It is demonstrated that the temperature sensors used in the present detection scheme are able to differentiate between local hotspots (e.g. simulated using adjacent ring oscillators running at 8.06 GHz) and raised temperatures due a laser spot used in a LVP attack.

FIG. 6 is a graph 600 showing transient measurements detected using the system architecture of FIG. 3 under a LVP attack in accordance with an embodiment. In the present embodiment, the transient measurements of 10% to 90% Vₛₑₙₛₑ rise/fall time under a LVP attack using a 1319 nm laser on-silicon having a power of 6.08 mW.

As shown in the graph 600, a voltage output (V_{sense P}) 602 (c.f. FIG. 3) associated with the PMOS cluster leakage measured using the temperature sensors has a mean rise/fall time of 132.7 μs with a standard deviation a of 34.5 μs, while a voltage output (V_{sense N}) 604 (c.f. FIG. 3) associated with the NMOS cluster leakage measured using the temperature sensors has a mean rise/fall time μ of 150.1 μs with a standard deviation a of 41.8 μs. The temperature sensors have consistently sub-milli-seconds response time as shown in the graph 600.

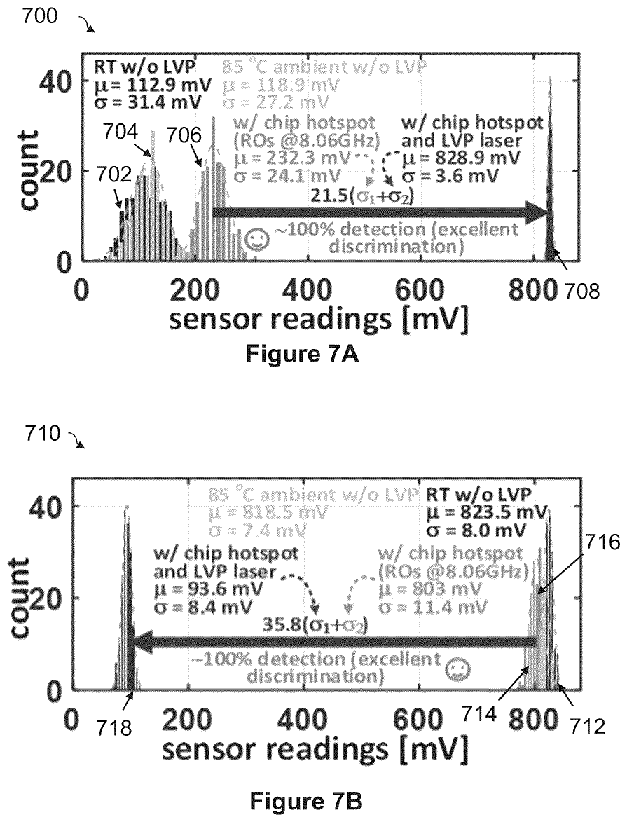

FIGS. 7A and 7B are graphs 700, 710 to illustrate effects of thermal process variations on detection using the system architecture of FIG. 3 in accordance with an embodiment. In the present embodiment, a LVP attack on the test chip 500 was performed using a 1319 nm laser on-silicon having a power of 6.08 mW. It is noted that a supply noise due to the AES chip is at 20 MHz.

In the present embodiment, four conditions were used for illustrating effects of thermal process variations for the graphs 700, 710. The four conditions are: (1) room temperature without a LVP attack, (2) at an ambient temperature of 85° C. without a LVP attack; (3) with hotspots/rises in on-chip temperatures induced using the ring oscillators operating at 8.06 GHZ on chip without a LVP attack and (4) with hotspots/rises in on-chip temperatures induced using the ring oscillators operating at 8.06 GHZ on chip with a LVP attack.

FIG. 7A shows a graph 700 to illustrate effects of thermal process variation in relation to signal outputs obtained using PMOS leakage currents of the temperature sensors. V_{sense P} histograms associated with each of these four conditions are plotted in the graph 700.

As shown in the graph 700, a V_{sense P} histogram 702 associated with condition (1) above has a mean sensor reading p of 112.9 mV with a standard deviation a of 31.4 mV, a V_{sense P} histogram 704 associated with condition (2) above has a mean sensor reading p of 118.9 mV with a standard deviation a of 27.2 mV, a V_{sense P} histogram 706 associated with condition (3) above has a mean sensor reading p of 232.3 mV with a standard deviation a of 24.1 mV and a V_{sense P} histogram 708 associated with condition (4) above has a mean sensor reading p of 828.9 mV with a standard deviation a of 3.6 mV.

FIG. 7B shows a graph 710 to illustrate effects of thermal process variation in relation to signal outputs obtained using NMOS leakage currents of the temperature sensors. The aforementioned four conditions were used and V_{sense N} histograms associated with each of these four conditions are plotted in the graph 710.

As shown in the graph 710, a V_{sense N} histogram 712 associated with condition (1) above has a mean sensor reading p of 823.5 mV with a standard deviation a of 8.0 mV, a V_{sense N} histogram 714 associated with condition (2) above has a mean sensor reading p of 818.5 mV with a standard deviation a of 7.4 mV, a V_{sense N} histogram 716 associated with condition (3) above has a mean sensor reading p of 803 mV with a standard deviation a of 11.4 mV and a V_{sense N} histogram 718 associated with condition (4) above has a mean sensor reading p of 93.6 mV with a standard deviation a of 8.4 mV.

As shown in relation to the graphs 700, 710, the temperature sensors of the present embodiment can easily differentiate between local hotspots induced e.g. by adjacent ring oscillators running at 8.06 GHz and rises in temperature due to a laser spot used in a LVP attack. This is evidenced by large output voltage differences, in a range of 0.6V to 0.7 V as shown by the graphs 700, 710 in relation to FIGS. 7A and 7B. Further, using the data as shown in the graphs 700, 710, a worst-case scenario associated with the discrimination between an occurrence of a LVP attack (i.e. condition (4)) and having no attack (i.e. condition (3)) is of a 21.5-a margin as shown in the graph 700. This still provides excellent discrimination between an occurrence of a LVP attack and having no attack, even under the condition where local temperature hotspots are induced by the running ring oscillators at 8.06 GHz. This excellent discrimination is due to the exponential dependence of leakage current versus temperature as utilised in the present temperature sensors, as well as the high local laser power density associated with LVP attacks.

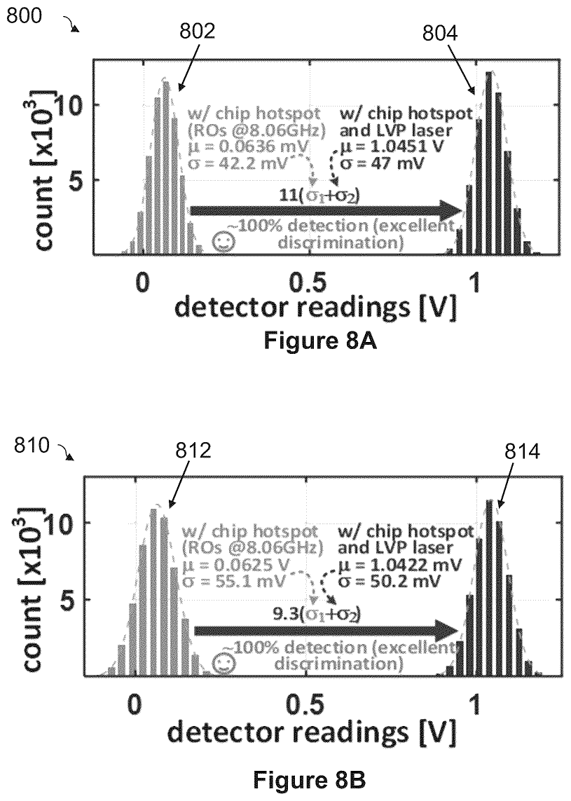

FIGS. 8A and 8B are graphs 800, 810 to illustrate effects of temporal noise on detection using the system architecture of FIG. 3 in accordance with an embodiment. The effects of temporal noise were measured using 50,000 measurements for each of these graphs. In the present embodiment, a LVP attack on the test chip 500 was performed using a 1319 nm laser on-silicon having a power of 6.08 mW. It is noted that a supply noise due to the AES chip is at 20 MHz.

In the present embodiment, two conditions were used for illustrating effects of temporal noise on detection for the graphs 800, 810. The two conditions are: (i) with hotspots/rises in on-chip temperatures induced using the ring oscillators operating at 8.06 GHZ on chip without a LVP attack and (ii) with hotspots/rises in on-chip temperatures induced using the ring oscillators operating at 8.06 GHZ on chip with a LVP attack.

FIG. 8A shows a graph 800 to illustrate effects of temporal noise in relation to PMOS sensors. V_{detect P} histograms associated with each of these two conditions are plotted in the graph 800. As shown in the graph 800, a V_{detect P} histogram 802 associated with condition (i) above has a mean detector reading p of 0.0636 mV with a standard deviation a of 42.2 mV, and a V_{detect P} histogram 804 associated with condition (ii) above has a mean detector reading p of 1.0451 V with a standard deviation a of 47 mV.

FIG. 8B shows a graph 810 to illustrate effects of temporal noise in relation to NMOS sensors. V_{detect N} histograms associated with each of these two conditions are plotted in the graph 810. As shown in the graph 810, a V_{detect N} histogram 812 associated with condition (i) above has a mean detector reading μ of 0.0625 mV with a standard deviation a of 55.1 mV, and a V_{detect N} histogram 814 associated with condition (ii) above has a mean detector reading μ of 1.0422 V with a standard deviation a of 50.2 mV.

As shown by the graphs 800, 810, a worst-case scenario associated with the discrimination between an occurrence of a LVP attack (i.e. condition (ii)) and having no attack (i.e. condition (i)) is of a 9.3-σ margin under temporal noise as shown in the graph 810 with 50,000 measurements.

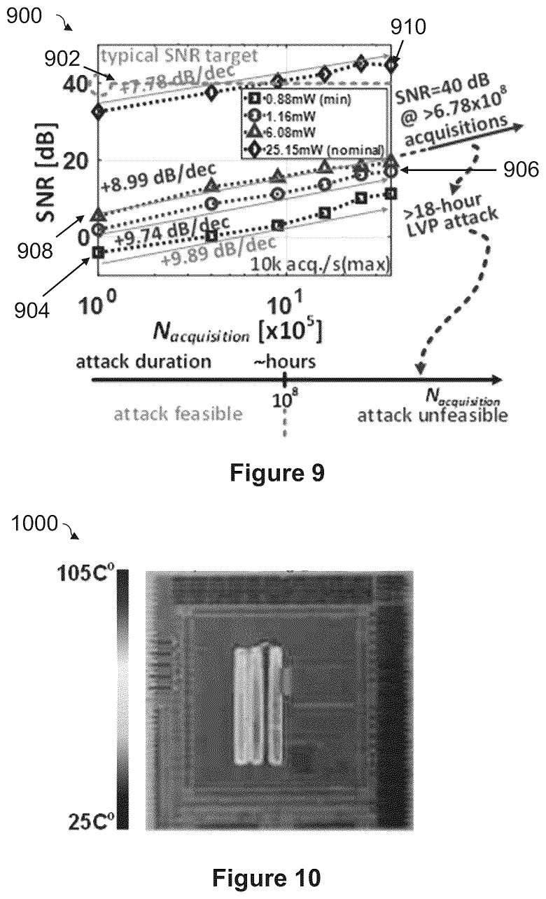

FIG. 9 shows a graph 900 of measured signal to noise ratio (SNR) of LVP waveforms versus a number of acquisitions of a LVP attack having various laser powers in accordance with an embodiment. A 1319 nm laser on-silicon was used to perform LVP attacks with a best-in-class laser spot size of approximately 220 nm on a protected AES core on a chip to obtain the LVP waveforms using different laser powers. Four different laser powers were used and these are 0.88 mW, 1.16 mW, 6.08 mW and 25.15 mW. The acquisition rate used in the present case is 10k acquisitions per second, which is a maximum allowed rate at full speed of the chip.

Referring to the graph 900, a dotted line 902 is shown which represents a typical SNR target for feasible extraction of data. Also shown in the graph 900 includes a plot 904 for the laser power of 0.88 mW, a plot 906 for the laser power of 1.16 mW, a plot 908 for the laser power of 6.08 mW and a plot 910 for the laser power of 25.15 mW. The plot 904 can be linearly fitted to obtain a gradient of +9.89 dB/dec. Similarly, the plots 906, 908, 910 can be linearly fitted to obtain a gradient of +9.74 dB/dec, +8.99 dB/dec and +7.78 dB/dec, respectively.

It is noted that LVP attacks are feasible (e.g. by noise averaging to recover a LVP signal) only if the attacks are concluded typically within a few hours, as thermal and mechanical equipment/die/optics drifts prohibit correct averaging for recovering a LVP signal and prevent SNR improvements over an extended attack duration. As an illustration, by extrapolation the plot 908 associated with the laser power of 6.08 mW, it is noted that more than 6.78×10⁸ acquisitions are required in order to achieve the SNR target of 40 dB. This translates to more than 18 hours of LVP attack required at an acquisition rate of 10k acquisitions per second, which makes a LVP attack at the laser power of 6.08 mW unfeasible. Nevertheless, as shown in the graph 900, the detection method and system of the present disclosure is still able to detect laser beams having very low laser power (at a minimum of 0.88 mW in this case). Thus, detection sensitivity of the present system and method is still sufficient to detect attacks even when the attacker aggressively lowers the laser power to the point that the attack becomes unfeasible.

FIG. 10 shows an infrared thermal image 1000 of an array of temperature sensors on a chip having ring oscillators running at a frequency of 8.06 GHz in accordance with an embodiment. This illustrates the temperature hotspots or rises in temperature generated in the chip by the running ring oscillators.

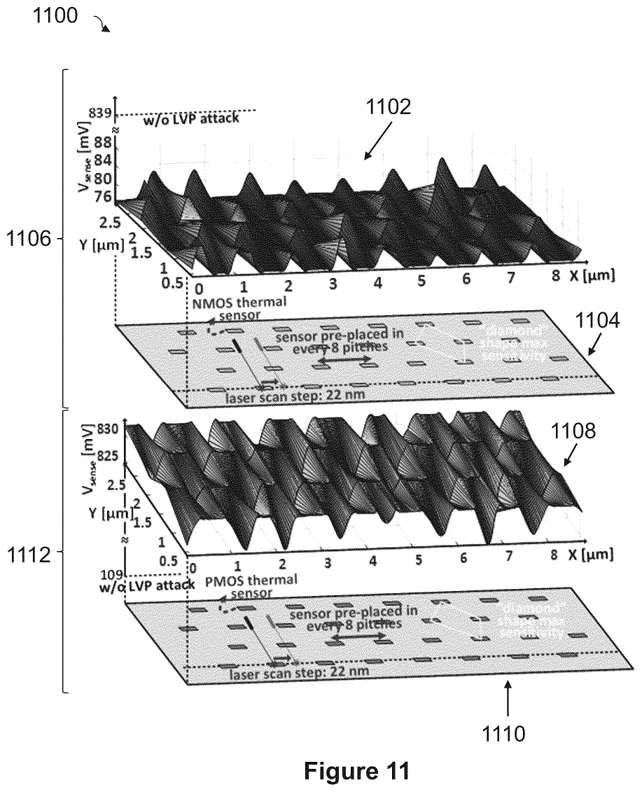

FIG. 11 shows diagrams 1100 illustrating successful detection of a LVP laser beam using the layout of the plurality of the temperature sensors of FIG. 2 in accordance with an embodiment. Similar to earlier experiments, a 1319 nm laser on-silicon was used and the laser was swept across an area of the test chip 500 using 22 nm steps. In the present case, measured responses of thirty-two distributed temperature sensors in a sensor cluster (see e.g. FIG. 2) were shown.

An area contour plot 1102 of V_{sense N} together with a layout 1104 of the NMOS transistors of the temperature sensors are shown as 1106, while an area contour plot 1108 of V_{sense P} together with a layout 1110 of the PMOS transistors of the temperature sensors are shown as 1112. Similar to the temperature sensor layout as shown in relation to FIG. 2, the temperatures sensors were placed at every 8 poly pitches within each cell rows and are arranged in a diamond shape configuration to maximise detection sensitivity in the present case.

As shown in the plots 1102, 1108, successful detection of the LVP laser beam was achieved using the temperature sensor cluster.

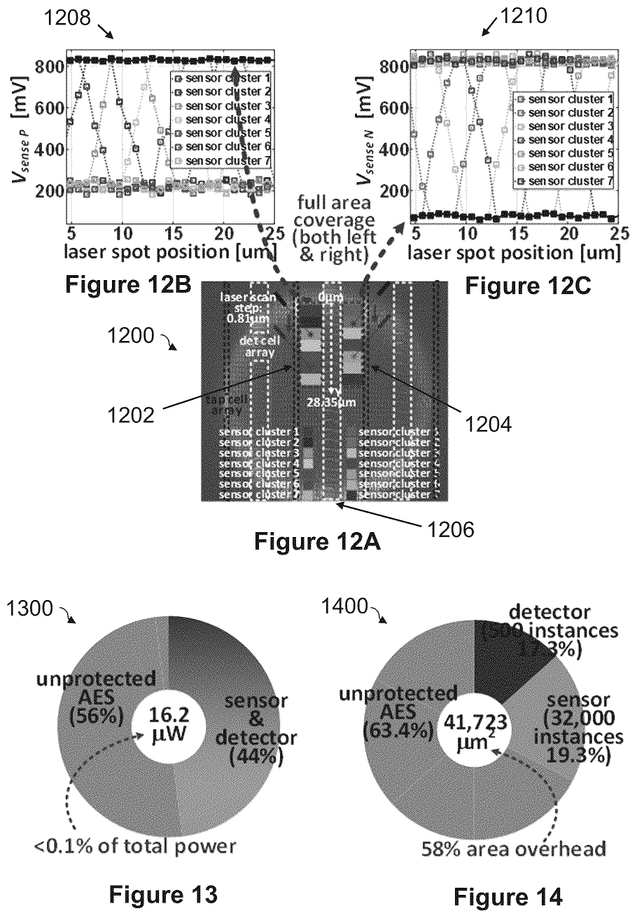

FIGS. 12A, 12B and 12C are diagrams illustrating detection of a LVP attack on a chip with full-area detection coverage using sensor clusters provided at a left-side and a right-side of a detector in accordance with an embodiment. A laser beam used for simulating the LVP attack was scanned with a step size of 0.81 μm.

FIG. 12A is a micrograph 1200 showing a portion of the chip having a full-area detection coverage using temperature sensors of FIG. 2. Particularly, seven sensor clusters (each comprising 32 temperature sensors) are provided at each of the left-side 1202 and the right-side 1204 of seven detectors 1206. There are therefore seven sets of sensor-detector units (i.e. each sensor-detector unit includes a detector and sixty-four temperature sensors, where the sixty-four temperature sensors include thirty-two temperature sensors in each sensor cluster on a left side and a right side of the detector) shown in FIG. 12A. Each of the sensor clusters are represented by a different shaded box as shown in the micrograph 1200. A LVP attack can be detected/monitored using these sensor-detector units.

FIG. 12B is a graph 1208 of sensing voltage V_{sense P} versus a position of a laser spot of the LVP attack measured using the left-side sensor clusters. The sensing voltage V_{sense P} obtained from leakage currents of PMOS transistors comprised in the temperature sensors of each of these left-side sensor clusters are shown with respect to the laser spot position.

FIG. 12C is a graph 1210 of sensing voltage V_{sense N} versus a position of the laser spot of the LVP attack measured using the right-side sensor clusters. The sensing voltage V_{sense N} obtained from leakage currents of NMOS transistors comprised in the temperature sensors of each of these right-side sensor clusters are shown with respect to the laser spot position.

Both the graphs 1208, 1210 show that different sensor clusters are activated when the laser spot of the LVP attack was swept through the sensor clusters at different positions. The black square data points as shown highlight outputs of the sensors in the sensor-detector pairs, in mV, in response to a LVP laser being shined or detected at each of the sensor clusters. For example, in the graph 1208, when there is no LVP attack, V_{sense P} detected by a sensor cluster is ~200 mV (c.f. FIG. 7A). When a LVP is detected, the V_{sense P} readings of the sensor cluster increases to >800 mV (c.f. FIG. 7A), as illustrated by black square data points in the graph 1208.

FIG. 13 shows a pie chart 1300 of a leakage power breakdown in accordance with an embodiment. The leakage power breakdown is dominated by dynamic power. The near-zero activity of detectors and logic circuitries makes any extra power required insignificant. It is noted that the power required for the temperature sensors and detectors relates only to power leakage and it is of less than 0.1% of the total power used in the chip. To obtain the power required for the temperature sensors and detectors as a percentage of the total power, a total power consumption of the AES processor/chip comprising the detectors and the temperature sensors, and a power consumption of detectors and the temperature sensors are measured separately. The ratio of the power required for the temperature sensors and detectors to the total power can then be calculated.

FIG. 14 shows a pie chart 1400 of a silicon area breakdown in accordance with an embodiment. The 58% area overhead is calculated as a ratio of the area of the detectors and sensors deployed on the chip to the total area of the chip (in this case, an AES core).

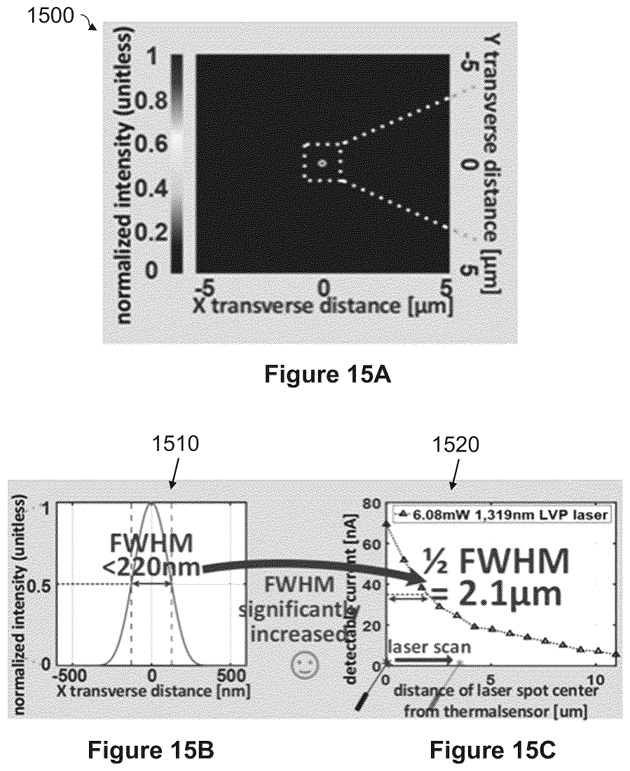

FIGS. 15A, 15B and 15C shows graphs to illustrate optical power distribution radius and thermal field radius of a laser beam spot in accordance with an embodiment. In the present experiments, a Gaussian laser beam spot was generated using a 1319 nm laser on-silicon. These graphs illustrate the advantages of thermal detection of LVP attacks as compared to existing detection of LVP attacks using optical detection, as exemplified by the reference [1] H. Zhang, L. Lin, Q. Fang, M. Alioto, “On-Chip Laser Voltage Probing Attack Detection with 100% Area Coverage at Above/Below the Bandgap Wavelength and Fully-Automated Design,” IEEE Symp. on VLSI Circuits, Honolulu (USA), June 2022, pp. 144-145.

FIG. 15A shows a 2D colour contour plot 1500 of normalised optical field intensity in relation to a X-transverse distance and a Y-transverse distance of the laser beam spot 1502. A plot 1510 of the normalised optical field intensity verse the X-transverse distance of the laser beam spot 1502 is shown in FIG. 15B. As shown by the plot 1510, the Full-Width Half-Maximum (FWHM) of the normalised intensity indicates a laser beam spot size of less than 220 nm. FIG. 15C shows a plot 1520 of detected current using a temperature sensor versus a distance of the laser beam spot centre from the temperature sensor. The FWHM of the detected current indicates a radius of a thermal field of about 2.1 μm.

Therefore, as shown in relation to the plots 1510, 1520, a radius of a thermal field induced by a laser beam spot of a LVP attack is much longer than a radius of an optical field (in this case, about half of 220 nm). Use of temperature sensors for detecting a LVP attack is therefore more effective and it also enables temperature sensors to be sparsely placed as compared to optical sensors due to the much larger thermal field radius of the laser spot of the LVP attack. This translates to lower costs and a lower area overhead. Other comparisons with the conventional optical detection scheme as exemplified by the reference are provided in Table 1 below.

TABLE 1
Comparisons between optical and thermal detection of LVP attacks

| | | Thermal detection |
|---|---|---|
| Detection method | Optical detection [1] | (present disclosure) |
| Implementation | Reverse-biased p-n junction | Off-transistor leakage |
| | photosensor | comparison |
| On-chip detection | Electron-positron (e⁻-h⁺) | Vₜₕ shrink due to |
| mechanism | generation due to photoelectric | temperature increase |
| | effect (two-photon absorption → | induced by laser beam |
| | e⁻-h⁺ pair much less than single | (exponential leakage |
| | photon → much lower induced | current induced by thermal |
| | current → low sensitivity) | → high sensitivity) |
| Placement | Sensor insertion needed next to | Sparse pre-placement to |
| | every transistor in standard cells | achieve 100% coverage, |
| | to achieve 100% coverage → | (sensor insertion only |
| | large area overhead | needed for large standard |
| | | cells) → small area- |
| | | overhead |
| Wavelength | Shorter might be undetected (e.g. | Full wavelength coverage |
| | 785 nm laser spot < distance to | due to high temperature, |
| | closest sensor) | regardless of wavelength |
| Detection radius | >220 nm (e.g. 1319 nm) | >4.2 μm (e.g. after 96% |
| @ 50% power | | optical attenuation) |
| (FWHM) | | Size of laser induced |
| | | thermal spot >> size of |
| | | optical spot |

Compared to the optical detection in the reference [1], the proposed scheme enables always-on laser detection at the most challenging above-bandgap wavelengths with full-area coverage at a 58% area overhead. This corresponds to a 2.5× overhead reduction over optical sensing in the reference [1] at a very similar security level. Further, as shown in relation to FIG. 6, the temperature sensors have consistently sub-milli-seconds response time as shown in the graph 600, which is more than 2.9 times faster than the optical sensors used in the reference [1].

### Comments

It is noteworthy that the sensors used in the present disclosure are temperature sensors and not photo-sensors.

The entire sensing scheme of the present embodiment is inherently robust against process/voltage/temperature variations because it is 1) differential, and 2) based on the comparison of leakage currents coming from transistor of the same type.

The embodiment in FIG. 3 shows at least one method to embed the detection scheme into a conventional standard cell-based design for truly distributed and in-situ sensing. It should be appreciated that other circuits that perform current comparison function can also be used as detector. The proposed detector is used because it is area-efficient (and hence cost-effective).

Although there are two transistors (to provide I_{sense P} and I_{sense N}) used in the above embodiments, it should be appreciated that any other form of circuitry that involves off-transistors used as temperature sensors would be applicable, because the basic idea here is to utilize the exponential dependence of leakage current of off-transistor on temperature. Since it is exponential, LVP attacks can be easily differentiated from other hotspots due to chip operation because it will induce a very high temperature (e.g. >400° C.).

### CONCLUSIONS

The system and method of the present disclosure provides integrated on-chip detection of LVP attack for counteracting LVP attacks using temperature sensors together with a detector or detection circuitry. The presence of transistor-scale laser beam spots of LVP attacks is detected by temperature sensors (in the present embodiment, off-state transistors) pre-placed at regular interval in the chip. As illustrated using FIGS. 7A to 8B, the temperature sensors used in detection can easily differentiate between local hotspots and rises in temperatures (>400° C.) contributed by adjacent ring oscillators running at 8.06 GHz from laser beam spots with at least a 21.5-σ margin.

As exemplified in relation to the description above, the system and method of the present disclosure achieve continuous monitoring of digital ICs at run time with 100% area protection coverage, while maintaining automated design principles and standard cell layout regulations (including constrained design guidelines) for easy integration and use within the present industrial standards. The temperature sensors together with detecting circuitries in the present embodiments possess laser sensing capabilities above and below the silicon bandgap. Calibration-free, automated and design-agnostic adoption are enabled by a standard-cell based methodology to achieve 100% protection coverage against laser voltage probing attacks, to offer a 58% area overhead and to exhibit inherent resilience to Process, Voltage, and Temperature (PVT) variations by using a self-referencing mechanism (see e.g. FIG. 3).

As described in relation to FIGS. 5 to 14, a prototype test-chip or test-structure was manufactured using an AES crypto core and the protection performance of the present system and method is shown using experimental silicon measurements. The system and method of the present disclosure uniquely enable detection of a LVP attack operated by a laser above a typical silicon or Ill-V bandgap wavelength, while offering a full-area coverage with detection of state-of-the-art deep sub-μm laser spots. Comparing with the exemplary reference [1], the present system and method utilising temperature sensors for on-chip design-agnostic LVP attack detection scheme achieved a full-area coverage with a reduction of an area overhead of 2.5 times. Based on thermal sensing, the present system and method utilising temperature sensors preserves automated standard cell design at less than 0.1% power overhead using a 28 nm test-chip.

Although two transistors are used in a temperature sensor in the present embodiments, it should be appreciated that one transistor or more than two transistors can be used in a temperature sensor in other embodiments as long as the one transistor or the more than two transistors are adapted to provide an increase in a leakage current in response to a rise in temperature caused by the LVP attack.

Further, as shown in relation to results illustrated in relation to e.g. FIGS. 7A and 7B or FIGS. 8A and 8B, using leakage currents associated with PMOS transistors or NMOS transistors of temperature sensors would be sufficient to detect a LVP attack and so it may not be necessary to include both types of transistors as exemplified in relation to FIG. 3. In a more general sense therefore, at least one transistor adapted to provide an increase in a leakage current in response to a rise in temperature caused by the LVP attack for detecting the LVP attack on a chip will be sufficient.

The present disclosure provides a method and a system for LVP detection using an off-state transistor, by making use of an increase in its leakage current in response to a rise in temperature caused by the LVP attack. Therefore, although in the present embodiment, two off-state transistors are comprised in a temperature sensor, in other embodiments, one off-state transistor may be sufficient. Similarly, although the present disclosure provides the use of two sensor clusters for connecting to a detector circuit for detection, one or more than two sensor clusters may be applicable. Other configurations of the sensor cluster(s) and/or the detector circuit can be used based on the detection principle of using an increase in a leakage current of an off-state transistor in response to a rise in temperature caused by the LVP attack. The leakage current of an off-state transistor may include a gate leakage current.

Alternative embodiments may include: (i) temperature sensors being arranged at less than or more than 8 poly pitches away from one another; (ii) a sensor cluster having varying cluster sizes e.g. 5, 6, 7, 10, 16, 20, 24 etc. of temperature sensors; (iii) detection of a LVP attack is not limited to the exemplified AES core but may extend to other components on the chip or a computer system; (iv) a detector adapted to detect leakage currents from one of or both of the PMOS transistor and NMOS transistor of each of the temperature sensors in the two sensor clusters. In an embodiment, where only PMOS leakage currents or NMOS leakage currents are used for detection, then only one of the two sensor clusters is able to detect presence of a LVP attack; (v) temperature sensors for detecting a LVP attack being arranges in other configuration or shapes, e.g. square, rectangle, triangle etc.; (vi) use of other logic circuitry for LVP detection measurements from the temperature sensors beside the use of skewed inverters and/or XNOR logic gate as shown in the present examples; and (vii) different predetermined ratio for determining wherein a count for the LVP attack is registered if a ratio between the first leakage current and the second leakage current exceeds a predetermined ratio.

Although only certain embodiments of the present invention have been described in detail, many variations are possible in accordance with the appended claims. For example, features described in relation to one embodiment may be incorporated into one or more other embodiments and vice versa.

1. A system for detecting a laser voltage probing (LVP) attack on a chip, the system comprising:
temperature sensors provided at predetermined intervals on the chip, each of the temperature sensors comprising at least one transistor in an off-state,
wherein the at least one transistor of each temperature sensor is adapted to provide an increase in a leakage current in response to a rise in temperature caused by the LVP attack for detecting the LVP attack on the chip.

2. The system of claim 1, wherein the temperature sensors are formed into sensor clusters, each of the sensor clusters including a predetermined number of the temperature sensors and are arranged at a predetermined distance from one another.

3. The system of claim 2, further comprising a detector adapted to be connected to a first and a second of the sensor clusters, the detector comprising a current comparator and a logic circuitry adapted to compare a first leakage current associated with the first sensor cluster and a second leakage current associated with the second sensor cluster, wherein a count for the LVP attack is registered if a ratio between the first leakage current and the second leakage current exceeds a predetermined ratio.

4. The system of claim 3, wherein the first sensor cluster comprises a first set of thirty-two of the temperature sensors, the first set of thirty-two of the temperature sensors being distributed in four cell rows with each cell row having eight of the first set of thirty-two of the temperature sensors and the second sensor cluster comprises a second set of thirty-two of the temperature sensors, the second set of thirty-two of the temperature sensors being distributed in another four cell rows with each cell row having eight of the second set of thirty-two of the temperature sensors, the first sensor cluster and the second sensor cluster are arranged on opposite sides to each other and are placed symmetrically with respect to the detector.

5. The system of claim 4, wherein each of the temperature sensors is provided at eight poly-pitches from one another within each cell rows in the first sensor cluster and the second sensor cluster.

6. The system of claim 3, wherein the current comparator and the logic circuitry includes a pair of n-channel metal-oxide semiconductor (NMOS) current mirrors adapted to compare a respective p-channel metal-oxide semiconductor (PMOS) leakage current between the first sensor cluster and the second sensor cluster and a skewed inverter, the detector further comprises:
a further current comparator and a further logic circuitry including a pair of PMOS current mirrors adapted to compare a respective NMOS leakage current between the first sensor cluster and the second sensor cluster and a further skewed inverter; and
an XNOR logic gate adapted to generate a detector output based on a first output obtained using the pair of NMOS current mirrors and the skewed inverter and a second output obtained using the pair of PMOS current mirrors and the further skewed inverter,
wherein the first output is flipped if a ratio between the respective PMOS leakage current of the first sensor cluster and the second sensor cluster exceeds the predetermined ratio, and the second output is flipped if a ratio between the respective NMOS leakage current of the first sensor cluster and the second sensor cluster exceeds the predetermined ratio, and
wherein initial values of the first output and the second output includes a “1” and “0” binary pair as initial inputs to the XNOR logic gate, and the detector output generated by the XNOR logic gate is a high output or “1” if the first output or the second output is flipped.

7. The system of claim 1, wherein the temperature sensors are arranged in a diamond shape configuration on the chip.

8. The system of claim 1, wherein one or more of the temperature sensors are provided within a digital standard cell on the chip if a size of the digital standard cell exceeds a predetermined number of pitches on the chip.

9. The system of claim 1, wherein each temperature sensor comprises a first transistor having a first source and a first gate connected to a voltage source of a cell on the chip and a second transistor having a second source and a second gate connected to a ground of the cell.

10. A method for detecting a laser voltage probing (LVP) attack on a chip, the method comprising:
providing temperature sensors at predetermined intervals on the chip, each of the temperature sensors comprising at least one transistor in an off-state,
wherein the at least one transistor of each temperature sensor is adapted to provide an increase in a leakage current in response to a rise in temperature caused by the LVP attack for detecting the LVP attack on the chip.

11. The method of claim 10, further comprising forming the temperature sensors into sensor clusters, each of the sensor clusters including a predetermined number of the temperature sensors and are arranged at a predetermined distance from one another.

12. The method of claim 11, further comprising:
providing a detector adapted to be connected to a first and a second of the sensor clusters, the detector comprising a current comparator and a logic circuitry; and
comparing, using the detector, a first leakage current associated with the first sensor cluster and a second leakage current associated with a second sensor cluster,
wherein a count for the LVP attack is registered if a ratio between the first leakage current and the second leakage current exceeds a predetermined ratio.

13. The method of claim 12, wherein the first sensor cluster comprises a first set of thirty-two of the temperature sensors, the first set of thirty-two of the temperature sensors being distributed in four cell rows with each cell row having eight of the first set of thirty-two of the temperature sensors and the second sensor cluster comprising a second set of thirty-two of the temperature sensors, the second set of thirty-two of the temperature sensors being distributed in another four cell rows with each cell row having eight of the second set of thirty-two of the temperature sensors, the method further comprising: arranging the first sensor cluster and the second sensor cluster to be formed on opposite sides to each other and symmetrically placed with respect to the detector.

14. The method of claim 13, further comprising: providing each of the temperature sensors at eight poly-pitches from one another within each cell rows in the first sensor cluster and the second sensor cluster.

15. The method of claim 12, wherein the current comparator and the logic circuitry includes a pair of n-channel metal-oxide semiconductor (NMOS) current mirrors and a skewed inverter, and wherein the detector further comprises a further current comparator and a further logic circuitry including a pair of p-channel metal-oxide semiconductor (PMOS) current mirrors and a further skewed inverter, and an XNOR logic gate, the method further comprising:
comparing, using the pair of NMOS current mirrors and the skewed inverter, a respective PMOS leakage current between the first sensor cluster and the second sensor cluster, a first output associated with the current comparator and the logic circuitry is flipped if a ratio between the respective PMOS leakage current of the first sensor cluster and the second sensor cluster exceeds the predetermined ratio;
comparing, using the pair of PMOS current mirrors and the further skewed inverter, a respective NMOS leakage current between the first sensor cluster and the second sensor cluster, a second output associated with the further current comparator and the further logic circuitry is flipped if a ratio between the respective NMOS leakage current of the first sensor cluster and the second sensor cluster exceeds the predetermined ratio; and
generating, using the XNOR logic gate, a detector output based on the first output and the second output, wherein initial values of the first output and the second output includes a “1”, and “0” binary pair as initial inputs to the XNOR logic gate, and the detector output generated by the XNOR logic gate is a high output or “1” if the first output or the second output is flipped.

16. The method of claim 10, further comprising arranging the temperature sensors in a diamond shape configuration on the chip.

17. The method of claim 10, further comprising providing one or more of the temperature sensors within a digital standard cell on the chip if a size of the digital standard cell exceeds a predetermined number of pitches on the chip.

18. The method of claim 10, wherein each temperature sensor comprises a first transistor having a first source and a first gate connected to a voltage source of a cell on the chip and a second transistor having a second source and a second gate connected to a ground of the cell.
